(19) United States
(12) Patent Application Publication
(10) Pub. No.: US 2011/0317578 A1
(43) Pub. Date: Dec. 29, 2011

(54) SYSTEM AND METHOD FOR TRANSMITTING SERVICE DATA FROM A SERVER TO A TERMINAL VIA A BASE STATION

(75) Inventors: Tetsuo TOMITA, Kawasaki (JP); Bun Kimura, Kawasaki (JP)

(73) Assignee: FUJITSU LIMITED, Kawasaki-shi (JP)

(21) Appl. No.: 13/155,473

(22) Filed: Jun. 8, 2011

(30) Foreign Application Priority Data
Jun. 29, 2010 (JP) 2010-147617

(51) Int. Cl. H04W 24/00

(52) U.S. Cl. 370/252

(57) ABSTRACT

A base station transmits service data to a terminal at a first transmission rate. A server transmits the service data to the base station at a second transmission rate required for transmitting the service data. When the second transmission rate exceeds the first transmission rate, the server determines a part of the service data by thinning out the service data so that the part is able to be transmitted to the terminal at the first transmission rate. The server provides the determined part with marking information, and transmits the service data provided with the marking information to the base station at the second transmission rate. The base station extracts the part from the received service data based on the marking information provided for the part, and transmits the extracted part of the service data to the terminal at the first transmission rate.

### CROSS-REFERENCE TO RELATED APPLICATION

This application is based upon and claims the benefit of priority of the prior Japanese Patent Application No. 2010-147617, filed on Jun. 29, 2010, the entire contents of which are incorporated herein by reference.

### FIELD

The present invention relates to system and method for transmitting service data from a server to a terminal via a base station.

### BACKGROUND

In response to increase in amount of usable contents, a next-generation mobile communication system has been under consideration, and has been put into practical use. With the next-generation mobile communication system, a transmission rate for transmitting content data is improved to attain high-speed data transmission. Meanwhile, in parallel with implementation of a latest type of mobile communication systems, there remains a certain amount of demand for a mobile communication system of an old type in which a relatively low transmission rate is used. Therefore, it is conceivable that plural different types of mobile communication systems may coexist and be operated in parallel at the same time.

In the case where various types of mobile communication systems are operated in parallel, it is required to provide a user with a stable service over different types of mobile communication systems so as to allow the user to receive the service without regard to the type of mobile communication system in use. For example, it is important that stable service is continuously provided for the user even when a terminal used by the user has undergone a handover between different types of mobile communication systems.

For example, when a handover of a user terminal is performed from a source mobile communication system having a relatively high transmission rate, to a target mobile communication system having a relatively low transmission rate, there may be a possibility that a large amount of service data that is supposed to be transmitted at a high transmission rate, becomes unable to be utilized in the target mobile communication system to which a handover has been performed.

A method in which a user is able to transmit a sufficient amount of data even when a handover is performed between mobile communication systems each having a different transmission rate, has been under consideration.

Japanese Laid-open Patent Publications No. 2009-537089, No. 2005-328441, and No. 2004-312062 disclose a method for lessening deterioration of a QoS (Quality of Service) when a handover is performed between base stations each having a different transmission rate.

As mentioned above, in the case where a transmission rate varies greatly between different mobile communication systems, there is a possibility that a service becomes unable to be provided due to a shortage of an available transmission rate.

As a countermeasure against the above mentioned technical issue, it is conceivable that a transmission rate at which service data is to be provided, called a service rate, is made reduced, for example, by changing an encoding method used for high-capacity data transmission such as transmission of moving image data. Reduction of a service rate allows a service to be continued even after a handover has been performed to a mobile communication system having a relatively low transmission rate. On the other hand, there may be a limitation on reducing a service rate by changing an encoding method. When a service rate after changing an encoding method is still higher than an available transmission rate, it may be difficult to continue the service, as mentioned above.

Further, even when a handover is performed within the same mobile communication system, there may be cases where an available transmission rate changes significantly before and after the handover. For example, in the case of a 3.9G mobile communication system, since a single piece of resource is shared by a plurality of accommodated users, when a handover has been performed from a source cell accommodating a small number of users to a target cell accommodating a great number of users, a transmission rate available for one user may be significantly reduced. Therefore, even in the case of a handover within the same mobile communication system, a service might fail to be continuously provided, as mentioned above.

Moreover, not only when a handover is performed but also when an available transmission rate varies for some reasons, a service might fail to be continuously provided, depending on a service rate required for providing the service.

### SUMMARY

According to an aspect of an embodiment, there is provided a system for transmitting service data from a server to e terminal via a base station. The base station is configured to transmit service data to a terminal at a first transmission rate available for data transmission between the base station and the terminal. The server is configured to transmit the service data to the base station at a second transmission rate required for transmitting the service data. The base station notifies the server of the first transmission rate, and the server performs marking processing on the service data when the first transmission rate is less than the second transmission rate. In the marking processing, a part of the service data is determined by thinning out the service data so that the part is able to be transmitted to the terminal at the first transmission rate. Next, the determined part of the service data is provided with marking information, and the service data provided with the marking information is transmitted to the base station at the second transmission rate. The base station extracts the part from the received service data based on the marking information provided for the part of the service data, and transmits the extracted part of the service data to the terminal at the first transmission rate.

The object and advantages of the invention will be realized and attained by means of the elements and combinations particularly pointed out in the claims.

It is to be understood that both the foregoing general description and following detailed description are exemplary and explanatory and are not restrictive of the invention, as claimed.

### BRIEF DESCRIPTION OF DRAWINGS

FIG. 1 is a diagram illustrating a configuration example of a mobile communication system, according to an embodiment;

FIG. 2 is a diagram illustrating an example of a table for representing a relation between a transmission method and a transmission rate available for the transmission method, according to an embodiment;

FIGS. 3A, 3B, 3C are diagrams each illustrating an example of a communication status when transmitting service data from a server to a terminal via a base station;

FIGS. 4A, 4B are diagrams illustrating a transition example of a communication status caused by changing an encoding method;

FIGS. 5A, 5B are diagrams illustrating an example of a communication status when a handover is performed between base stations employing the same transmission method;

FIG. 6 is a diagram illustrating a configuration example of a base station, according to an embodiment;

FIG. 7 is a diagram illustrating a configuration example of a data server, according to an embodiment;

FIGS. 8A, 8B are diagrams illustrating an example of an operational sequence for performing a handover, according to an embodiment;

FIG. 9 is a diagram illustrating an example of an operational flowchart for handover processing performed by a source base station, according to an embodiment; and

FIG. 10 is a diagram illustrating an example of an operational flowchart for handover processing performed by a target base station, according to an embodiment;

FIG. 11 is a diagram illustrating an example of an operational flowchart for handover processing performed by a data server, according to an embodiment;

FIG. 12 is a diagram illustrating an example of an operational flowchart for transmission processing that is performed on service data by a target base station after a handover, according to an embodiment;

FIGS. 13A, 13B are diagrams illustrating an example of an operational sequence for performing a handover when a service rate of service data does not exceed a transmission rate available after a handover, according to an embodiment;

FIGS. 14A, 14B are diagrams illustrating an example of an operational sequence for performing a handover, in which a target base station transmits a transmission rate directly to a data server, according to an embodiment;

FIG. 15 is a diagram illustrating an example of a packet conveying service data including marked data, according to an embodiment;

FIGS. 16A, 16B, 16C are diagrams each illustrating an example of a transmission flow of packets conveying service data including marked data, according to an embodiment;

FIG. 17 is a diagram illustrating an example of an operational flowchart for marking processing performed by marker 214, according to an embodiment;

FIG. 18 is a diagram illustrating an example of an operational flowchart for marking processing performed by marker 214, according to an embodiment; and

FIG. 19 is a diagram illustrating an example of an operational flowchart for marking processing performed by marker 214, according to an embodiment.

### DESCRIPTION OF EMBODIMENTS

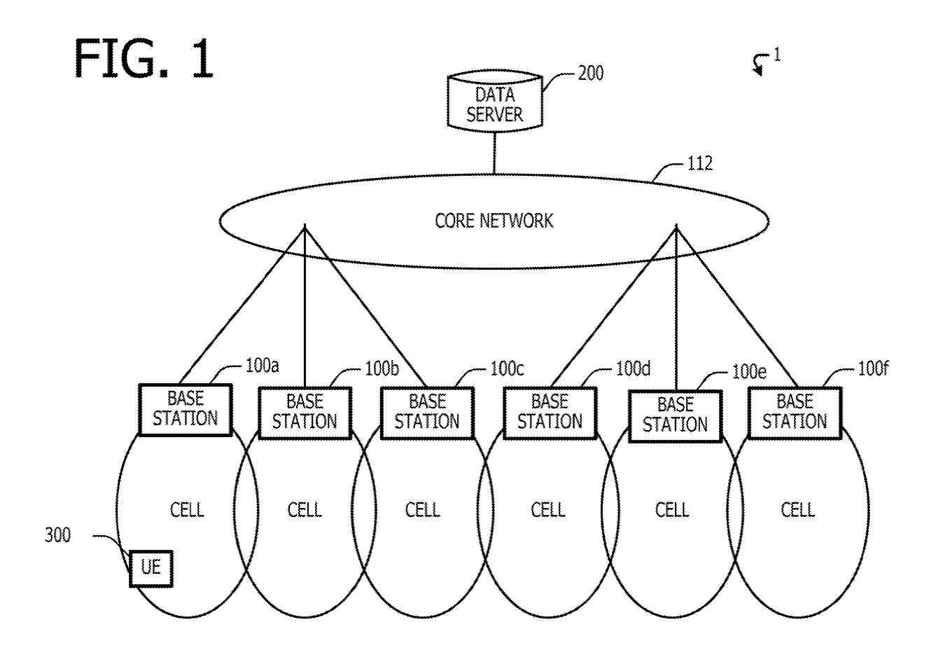

FIG. 1 is a diagram illustrating a configuration example of a mobile communication system, according to an embodiment. As depicted in FIG. 1, a mobile communication system according to an embodiment may be, for example, configured as mobile communication system 1 in which a plurality of base stations 100a to 100f are coupled to data server 200 via core network 112. Core network 112 may be configured to include one or more exchanges for exchanging packet data among base stations 100 and data server 200, and transmission of packet data among base stations 100 and data server 200 may be performed based on a predetermined transmission protocol. Base stations 100a to 100f each forms a radio communication area, called a cell, and communicates with user equipment (UE) 300, or a terminal, that is located within the cell. For example, in the example depicted in FIG. 1, UE 300 (a terminal) is located in a cell that is under control of base station 100a, and receives service data that is transmitted from data server 200 connected to core network 112, via base station 10a.

Hereinafter, when distinctions among base stations 100a to 100f are unnecessary, each of base stations 100a to 100f will be also expressed simply as “base station 100”. Further, hereinafter, a data server and user equipment (UE) will also be expressed as “a server” and “a terminal”, respectively. In the example of FIG. 1, although UE 300 (a terminal) is depicted only in the cell under control of base station 100a, UE 300 may be located in any one of cells depicted in FIG. 1.

In mobile communication system 1, base stations 100a to 100f may be configured to employ different transmission methods for transmitting data, respectively. In the example of FIG. 1, it is assumed that base stations 100a to 100c are configured to employ a first transmission method, and base stations 100d to 100f are configured to employ a second transmission method. Here, the transmission methods include, for example, a GSM (Global System for Mobile communications) of 2G (the second generation), and a LTE (Long Term Evolution) that is also referred to as 3.9G.

Since a different protocol is used for transmitting data in each of different transmission methods, a transmission rate at which service data is transmitted, called a service rate, may also be different in each of the different transmission methods. In general, a transmission rate available for a transmission method has a tendency to be greatly improved every time a generation change occurs in the transmission method.

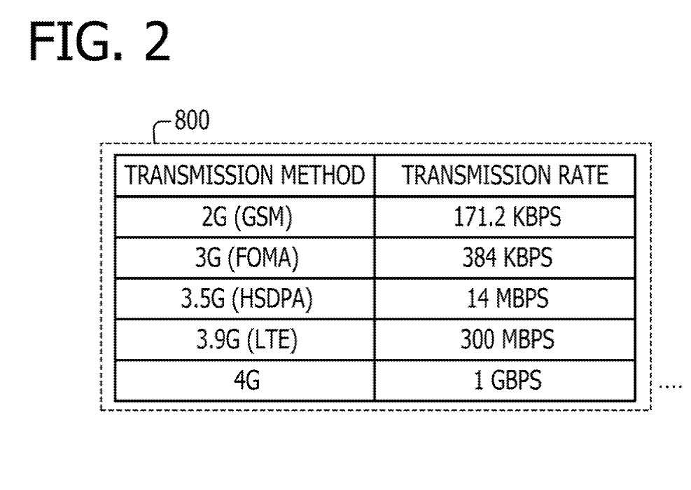

FIG. 2 is a diagram illustrating an example of a table for representing a relation between a transmission method and a transmission rate available for the transmission method. In the example of FIG. 2, a transmission rate available for a 2G of GSM is set at “171.2 Kbps”, a transmission rate available for a 3G of FOMA, or W-CDMA (Wideband Code Division Multiple Access), is set at “384 Kbps”, a transmission rate available for a 3.5G of HSDPA (High Speed Downlink Packet Access) is set at “14 Mbps”, a transmission rate available for a 3.9G of LTE is set at “300 Mbps”, and a transmission rate available for a 4G is set at “1 Gbps”. In examples that will be described later when a handover is performed between base stations each employing a different transmission method, it is assumed that a handover is performed from source base station 100c to target base station 100d, where source base station 100c employs a LTE method having a higher transmission rate, and target base station 100d employs a W-CDMA method having a lower transmission rate.

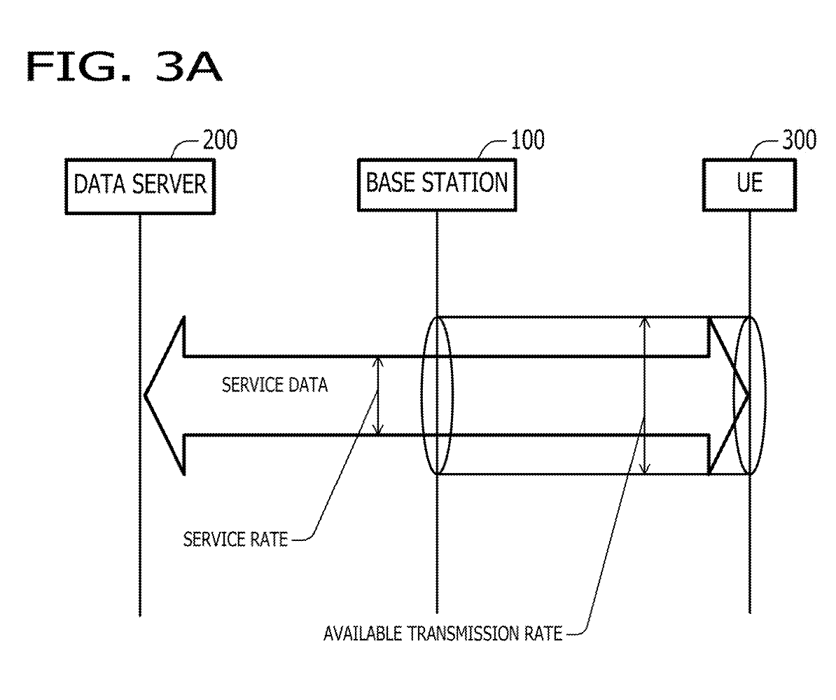

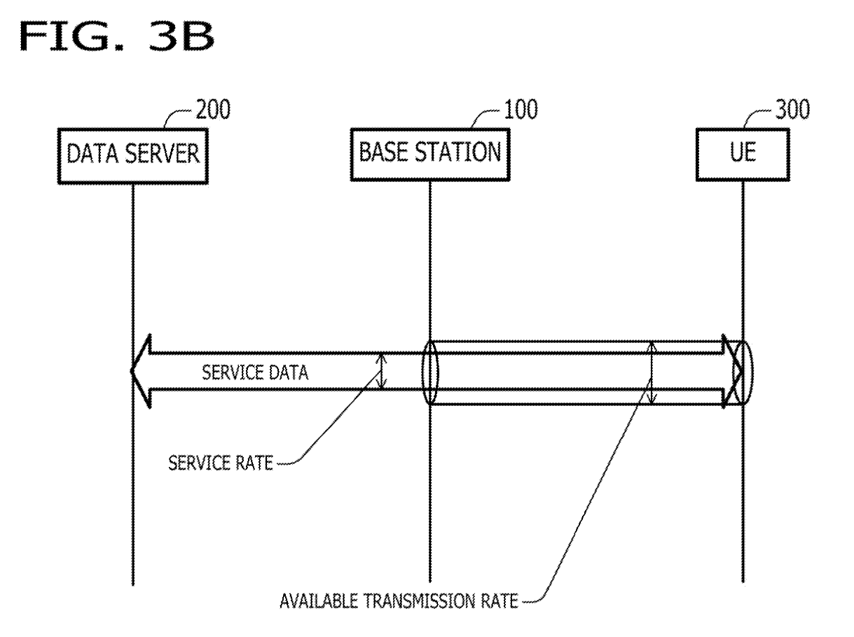

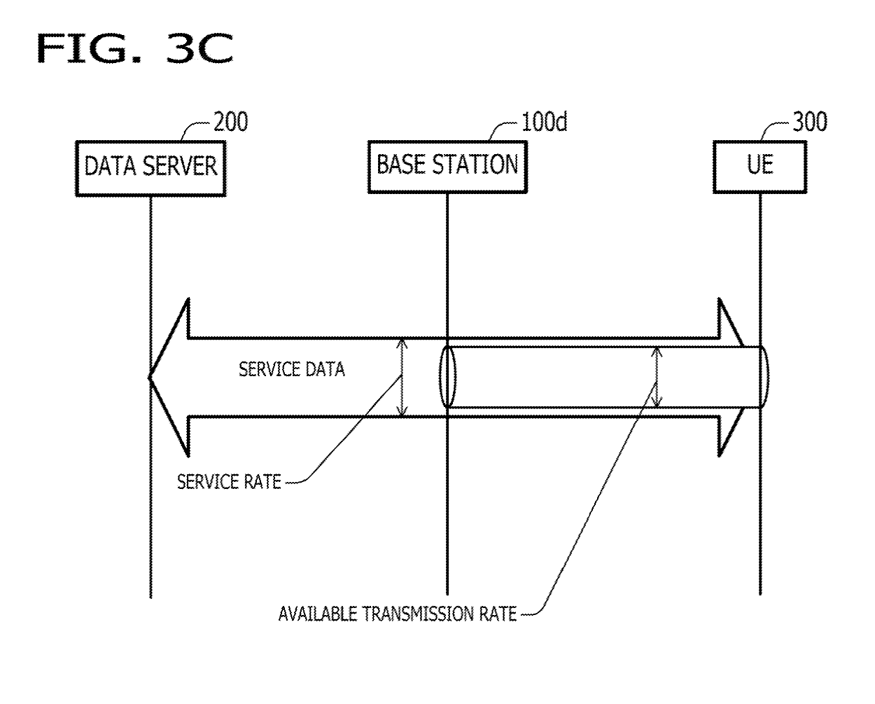

FIGS. 3A, 3B, 3C are diagrams each illustrating an example of a communication status when transmitting service data from a server to a terminal via a base station. In FIGS. 3A, 3B, 3C, a service rate indicates a transmission rate required for transmitting service data.

With a transmission method having a high transmission rate, it is possible to reserve a higher service rate (a higher transmission rate) for transmitting service data. For example, as depicted in FIG. 3A, when a transmission method employed for a radio link between base station 100 and UE 300 has a relatively high available transmission rate, service data may be transmitted at a relatively high service rate within the range of the available transmission rate. This allows data server 200 to transmit a larger amount of service data at one time, thereby enabling efficient transmission of a large volume of data such as moving image data. On the other hand, as depicted in FIG. 3B, when a transmission method employed for a radio link between base station 100 and UE 300 has a relatively low available transmission rate, service data may be transmitted only at a relatively low service rate within the range of the available transmission rate. In this case, since the amount of service data transmittable at one time is small, it is inadequate to transmit a large volume of data such as moving image data.

In mobile communication system 1 including a plurality of base stations 100 employing different transmission methods, when a handover occurs between base stations 100 each employing a different transmission method, an available transmission rate may significantly change before and after the handover. For example, as depicted in the example of FIG. 1, this may be the case when base stations 100a to 100c are employing a transmission method different from that employed by base stations 100d to 100f.

For example, in the case where a handover is performed from a source base station 100 employing a W-CDMA method to a target base station 100 employing a LTE method, an available transmission rate increases approximately by a factor of 1,000, allowing preferable transmission of service data.

On the other hand, when a handover is performed from a target base station 100 employing a LTE method to a source base station 100 employing a W-CDMA method, an available transmission rate decreases approximately by a factor of 1/1,000. This may impair the preferable transmission of service data. In the case where a service rate required for transmitting service data exceeds an available transmission rate, for example, when, as service data, a large volume of data such as moving image data is transmitted from data server 200 to UE 300 at the time of performing a handover, transmission of service data may not be performed in an appropriate manner.

FIG. 3C is a diagram illustrating an example of a communication status after a handover of UE 300 has been performed from a LTE type of base station 100c to a W-CDMA type of base station 100d. In the example of FIG. 3C, base station 100d indicates a W-CDMA type of base station. Since a service rate, which is required for transmitting the service data from LTE base station 100c to UE 300 before a handover, exceeds an available transmission rate, transmission of the service data from W-CDMA base station 100d to UE 300 after the handover may be impaired. In this case, some pieces of service data that have failed to be transmitted to UE 300 may be discarded, and only a part of service data that is transmittable at the available transmission rate is transmitted to UE 300. This may cause a technical problem of data loss. For example, in the case of transmitting moving image data, moving images may be fragmentarily reproduced.

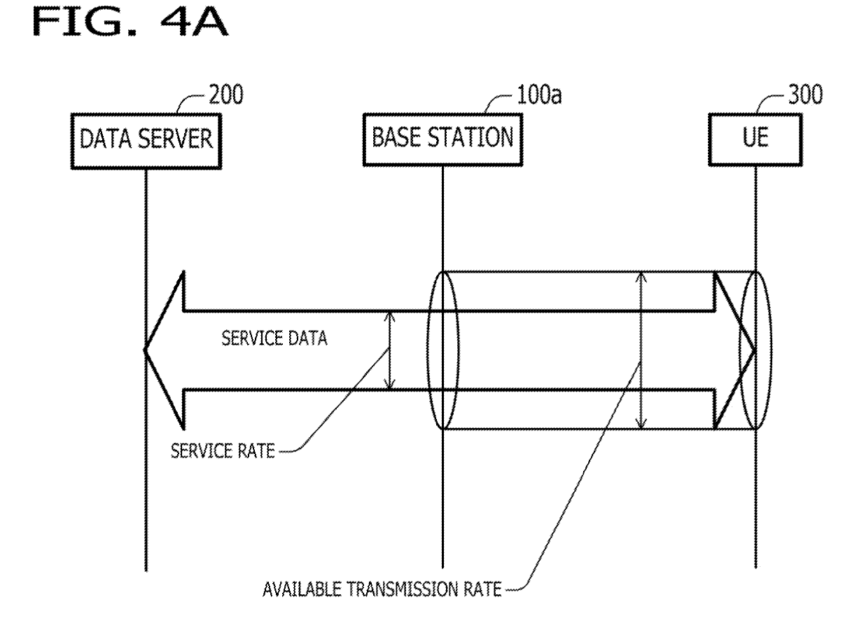

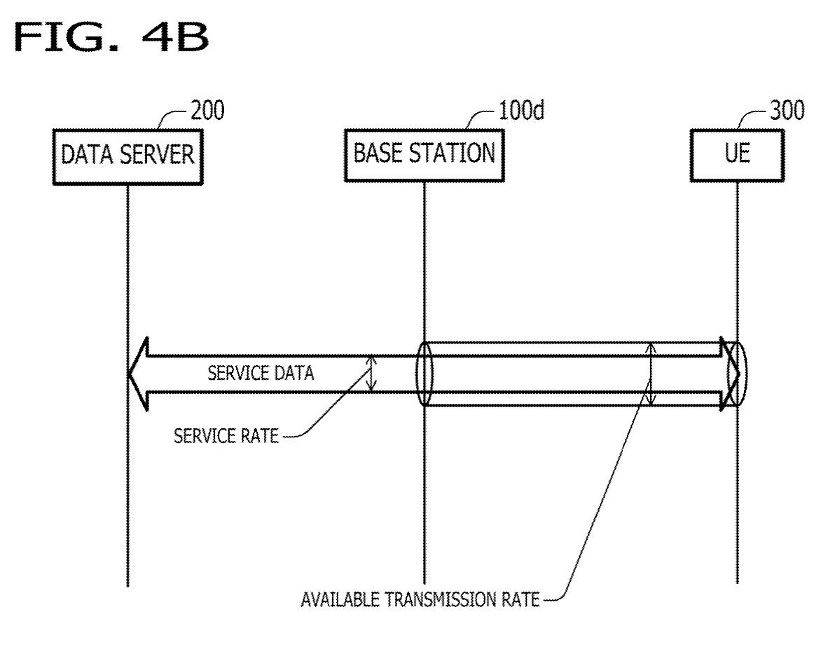

One solution to the above mentioned technical problem is to change a service rate depending on the communication situation. For example, in the case where service data is coded data such as moving image data, an encoding method used for generating the coded data may be changed so that a service rate of the coded data fall into the range of a transmission rate available for base station 100 after the handover. Here, description will be given of the above mentioned method for changing an encoding method with reference to FIGS. 4A, 4B.

FIGS. 4A, 4B are diagrams illustrating a transition example of a communication status caused by changing an encoding method. In the example depicted in FIGS. 4A, 4B, it is assumed that base station 100c of FIG. 4A has a relatively higher available transmission rate, base station 100d of FIG. 4B has a relatively lower available transmission rate, and a handover of UE 300 is performed from source base station 100c of FIG. 4A to target base station 100d of FIG. 4B. FIG. 4A illustrates an example of a communication status in which UE 300 is communicating with source base station 100c that has a relatively higher available transmission rate and is using a first encoding method for a higher service rate, before a handover is performed from source base station 100c to target base station 100d. FIG. 4B illustrates an example of a communication status in which UE 300 is communicating with target base station 100d that has a relatively lower transmission rate and is using a second encoding method for a low service rate, after the handover has been performed from source base station 100c to target base station 100d. As depicted in the example of FIGS. 4A, 4B, when a handover has been performed from source base station 100c to target base station 100d that has an available transmission rate lower than that of source base station 100a, a service rate required for transmitting the service data may be reduced by changing an encoding method for the service data, thereby allowing target base station 100d to transmit the service data to UE 300 without data loss. However, there may be a limit to the variation range of a service rate attained by changing an encoding method. For example, when an available transmission rate decreases extremely, such as in the case of a handover from a 4G base station to a 2G base station, it may be difficult to transmit service data without data loss.

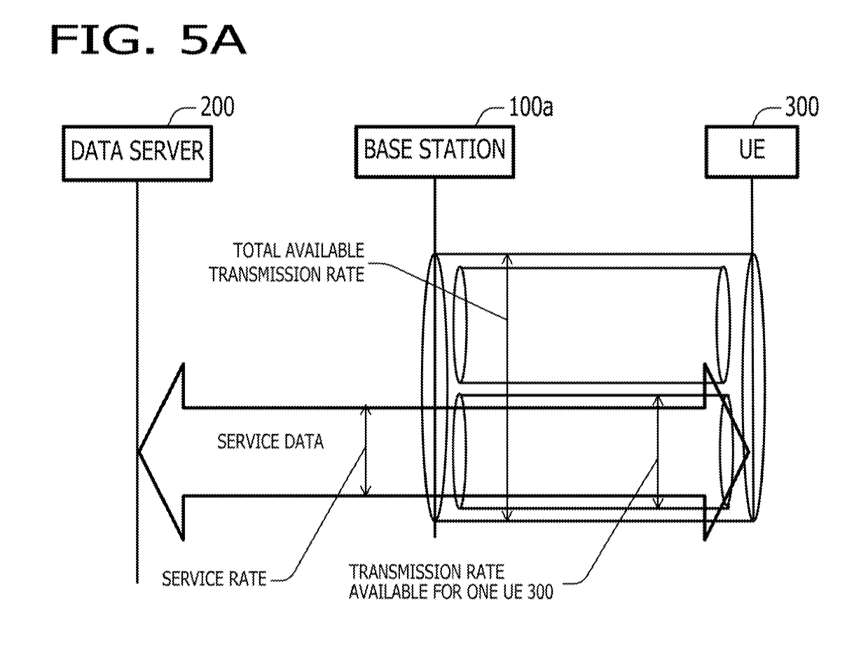

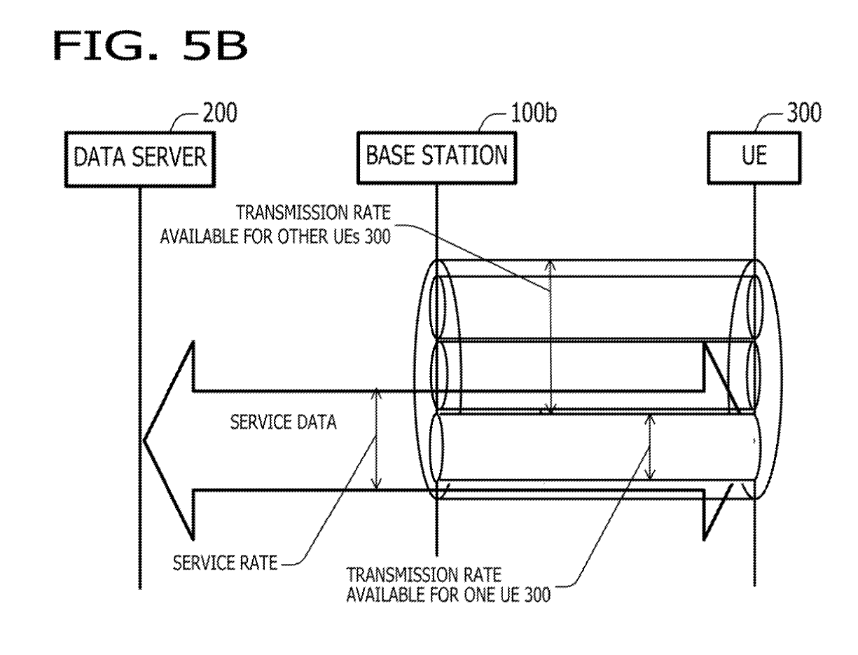

FIGS. 5A, 5B are diagrams illustrating an example of a communication status when a handover is performed between base stations employing the same transmission method. In the example depicted in FIGS. 5A, 5B, it is assumed that a handover of UE 300 is performed from source base station 100a of FIG. 5A to target base station 100b of FIG. 5B. FIG. 5A illustrates a communication status before the handover, and FIG. 5B illustrates a communication status after the handover. Even in the case of a handover between base stations employing the same transmission method, a transmission rate available for one terminal (UE 300) may be changed significantly before and after the handover. For example, in the case where LTE base station 100a accommodating a plurality of UEs 300, the plurality of UEs 300 may share one radio channel, as depicted in FIG. 5A. In this case, a transmission rate available for one UE 300 varies depending on the number of UEs 300 accommodated in LTE base station 100a. Therefore, in the case of a handover of UE 300 from source LTE base station 100a to target LTE base station 100b, when the number of UEs 300 accommodated in target LTE base station 100b is greater than the number of UEs 300 accommodated in source LTE base station 100a, a transmission rate available for one UE 300 may decrease before and after the handover, as seen from FIG. 5A (before the handover) and FIG. 5B (after the handover). This may impair transmission of service data for UE 300 that is performed by target LTE base station 100b after the handover because a transmission rate available for UE 300 by target LTE base station 100b falls below the transmission rate at which source LTE base station 100a is currently transmitting the service data to UE 300.

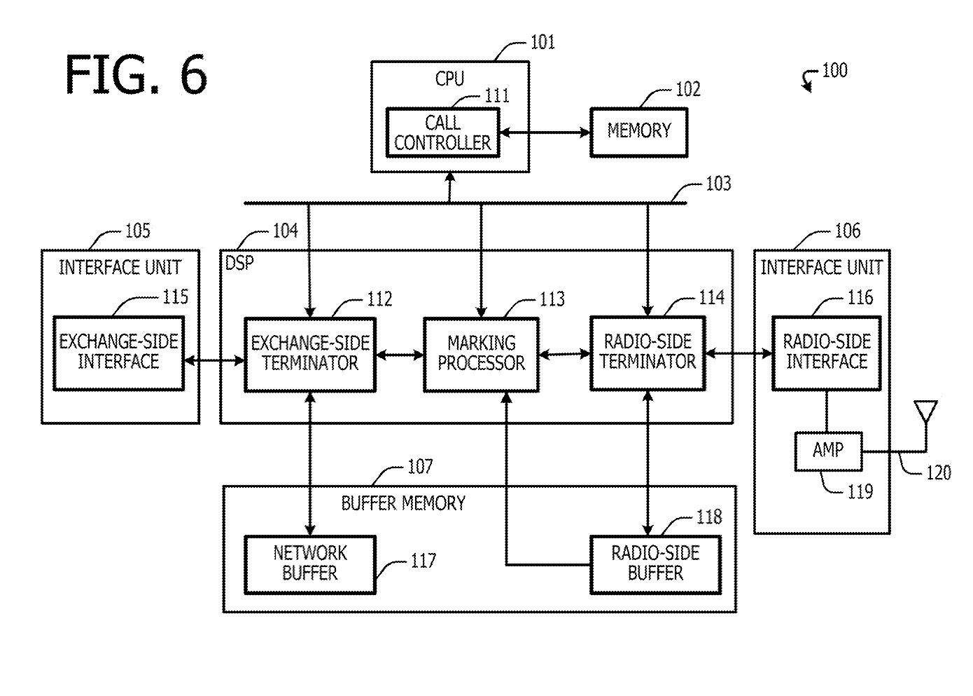

FIG. 6 is a diagram illustrating a configuration example of a base station, according to an embodiment.

Base station 100 includes CPU 101, memory 102, bus switch 103, DSP (Digital Signal Processor) 104, exchange-side interface unit 105, radio-side interface unit 106, and buffer memory 107.

CPU 101 is a controller for controlling whole the operations performed by base station 100. CPU 101 is connected to DSP 104 via bus switch 103, and performs transmission of signals for controlling the operations. Further, CPU 101 includes call controller 111 for performing call processing performed within base station 100, and controls an operation performed by each component, based on a communication status between base station 100 and UE 300.

In the case where a handover of UE 300 is performed from source base station 100c to target base station 100d, call controller 111 of the target base station 100d acquires resources, and calculates a transmission rate available for UE 300 that is determined depending on the acquired resources. Then, call controller 111 of target base station 100d transmits the calculated available transmission rate to source base station 100c via interface unit 105. Meanwhile, call controller 111 of source base station 100c, upon receiving the available transmission rate from target base station 100d, transmits the received available transmission rate to data server 200.

Memory 102 is a memory for storing data, such as program codes executed by CPU 101. CPU 101 may be configured to control each component within base station 100 by loading the program codes into memory 102.

DSP 104 performs signal processing in which packet data received from data server 200 via core network 112 is converted into data that is to be transmitted to UE 300. DSP 104 includes exchange-side terminator 112 for terminating signals received from core network 112, and radio-side terminator 114 for converting packet data that was received from exchange-side terminator 112 via radio-side buffer 118, into packet data complying with a radio communication protocol. Radio-side terminator 114 sends packet data that is stored in radio-side buffer 118, to radio-side interface 116 included in interface 106. DSP 104 further includes marking processor 113 that detects marking control information added to the service data that has been transmitted from data server 200 to base station 100, and transmits, to UE 300, a part of service data that was extracted from the service data based on the marking control information added to the service data.

Interface unit 105 may be configured to perform an interface function for communicating with a higher level node connected to core network 112, such as data server 200, or the other base stations 100, for example, via exchanges (not depicted in FIG. 1) arranged in core network 112. Exchange-side interface 115 included in interface unit 105 performs data transmission between exchanges arranged in core network 112 and base station 100.

Interface unit 106 may be configured to perform an interface function for communicating with UE 300 located in a cell that is under control of base station 100. For example, radio-side interface 116 included in interface unit 106a forms a cell under control of base station 100 via antenna 120, and performs data transmission between base station 100 and UE 300 within the formed cell using a radio-signal which is amplified by amplifier (AMP) 119 and transmitted via antenna 120.

Buffer memory 107 is a memory for temporarily storing data that is to be processed by DSP 104. Buffer memory 107, for example, may be configured to include network buffer 117 and radio-side buffer 118. The network buffer 117 temporarily stores packets conveying service data that was received from core network 112, and the radio-side buffer 118 temporarily stores data that is to be transmitted to UE 300.

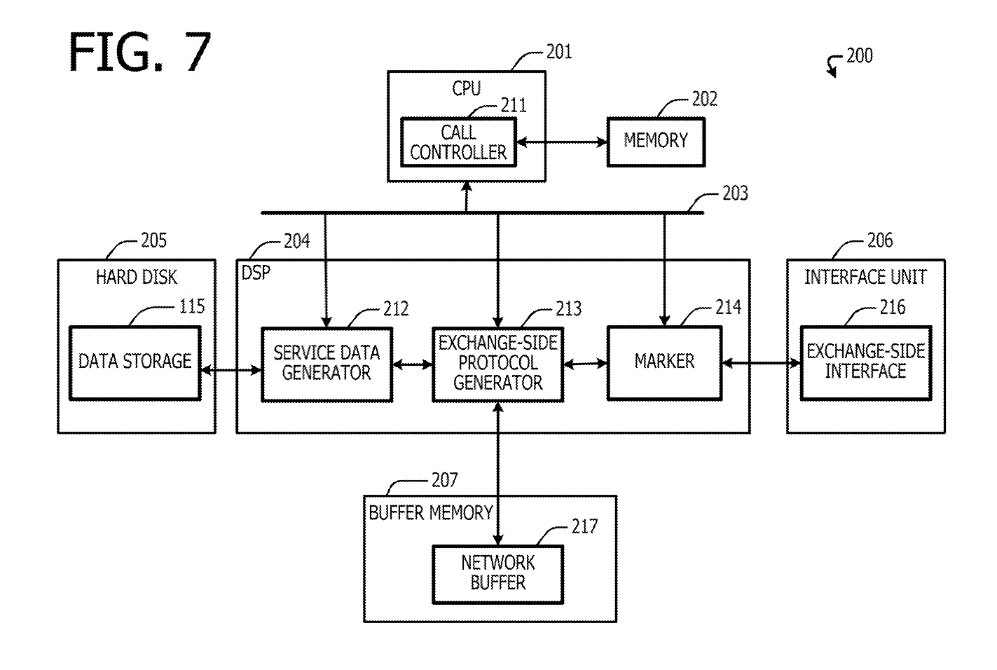

FIG. 7 is a diagram illustrating a configuration example of a data server, according to an embodiment.

Data server 200 may be configured to include, for example, CPU 201, memory 202, bus switch 203, DSP 204, hard disk 204, interface unit 206, and buffer memory 207.

CPU 201 is a controller for controlling whole the operations performed by data server 200. CPU 201 is connected to DSP 204 via bus switch 203, and performs transmission of signals for controlling the operations. Further, CPU 201 includes call controller 211 for performing call processing within data server 200.

Call controller 211 of data server 200 controls an operation of each component included in data server 200 so that data server 200 transmits service data to UE 300 via base station 100, based on a communication status between base station 100 and UE 300. Further, call controller 211 determines whether marking processing for providing the service data with marking information is necessary or not, by comparing a transmission rate available for target base station 100 to which a handover of UE 300 is to be performed, with a service rate required for transmitting service data that is currently being provided for UE 300. Then, call controller 211 sends an instruction on the marking processing to marker 214, based on the determination result.

Memory 202 is a memory for storing data, such as program codes executed by CPU 201. CPU 201 may be configured to control each component within data server 200 by loading the program codes into the memory 202, and by executing the loaded program codes.

DSP 204 may be configured to generate, in response to a transmission request from UE 300, service data to be transmitted, from a content file that was read out from hard disk 205, so as to transmit the generated service data to base station 100 via core network 112. DSP 204 may be configured to include service data generator 212 and exchange-side protocol generator 213. The service data generator 212 generates service data to be transmitted, from the content file that was read out from hard disk 205. The exchange-side protocol generator 213 generates a plurality of packets for conveying the service data so that each of the plurality of packets includes a protocol header for controlling transmission of the plurality of packets based on a predetermined transmission protocol, or an exchange-side protocol, the protocol header being used for transmitting packet data via core network 112. DSP 204 further includes marker 214 that performs marking processing on service data, according to an instruction that is given by call controller 211, for example, when an available transmission rate of target base station 100 falls below a service rate required for transmitting the service data.

In marking processing, marker 214 determines a part of service data by thinning out the service data so that the part is able to be transmitted from base station 100 to a terminal (UE 300) at an available transmission rate, and provides the determined part of service data with marking information, so as to transmit the service data provided with the marking information to base station 100 at a service rate required for transmitting the service data. Base station 100, upon receiving the service data from data server 200, extracts the part of service data from the received service data based on the marking information provided for the part of service data, and transmits the extracted part of service data to the terminal (UE 300) at the transmission rate available for base station 100.

In order to perform the above mentioned marking processing, two types of control information, first marking control information and second marking control information, are used for each of a plurality of packets conveying the service data. The first marking control information indicates whether marking control is necessary for the service data or not, in other words, whether the service data includes marked data or not. Therefore, as the first marking information, the same value is set to all the plurality of packets conveying the same service data. For example, first marking control information may be configured as flag information that is set at a value of “ON” when marking control is necessary, and set at a value of “OFF” when marking control is unnecessary.

The second marking control information indicates whether the packet conveys a piece of marked data or not. For example, the second marking information may be configured as flag information that is set at a value of “ON” when the packet stores a piece of marked data, and is set at a value of “OFF” when the packed does not store marked data at all. Hereinafter, for ease of explanation, second marking control information set at value “ON” will be also expressed as “marking information”, and a part of service data to which second marking control information having value “ON” is added, will be also expressed as “marked data”. In the same way, a packet to which second marking control information having value “ON” is added will be expressed as “a marked packet”.

Hard disk 205 includes data storage 115 for storing content files that are to be provided for terminals (UEs) by data server 200. Data storage 115 may be configured to read out an intended content file from the stored content files, and to send the intended content file to DSP 204.

Interface unit 206 may be configured to perform an interface function for communicating with base station 100 via core network 112. For example, exchange-side interface 216 included in interface unit 206 performs data transmission between data server 200 and base station 100 via core network 112.

Buffer memory 207 is a memory for temporarily storing data to be processed by DSP 204. Buffer memory 207, for example, may be configured to include network buffer 217 for temporarily storing a content file that was read out from data storage 215.

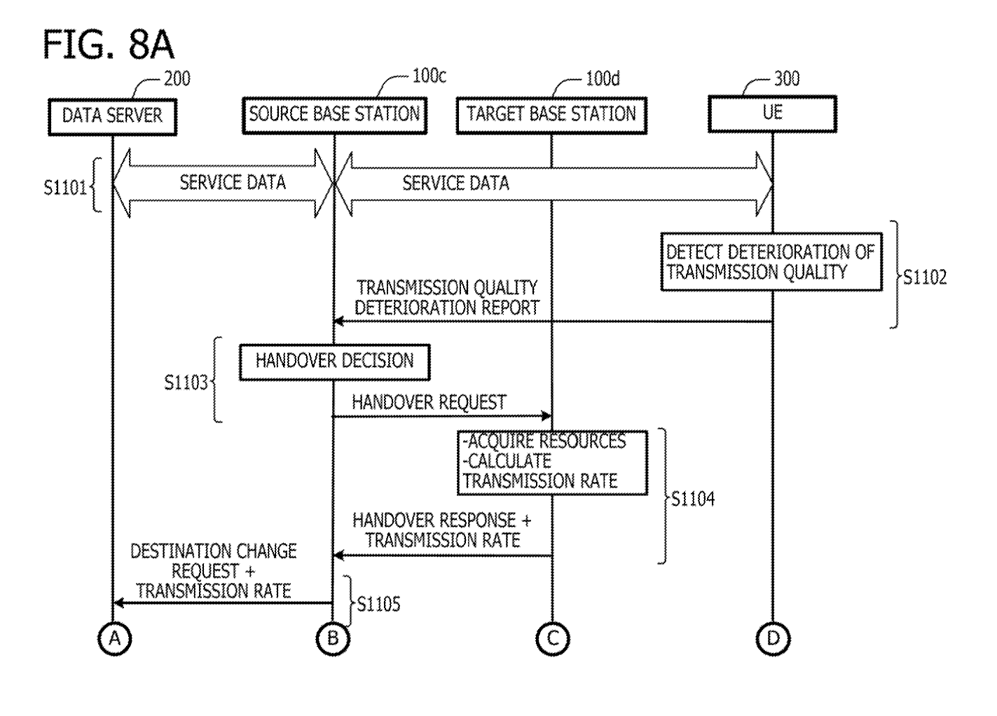

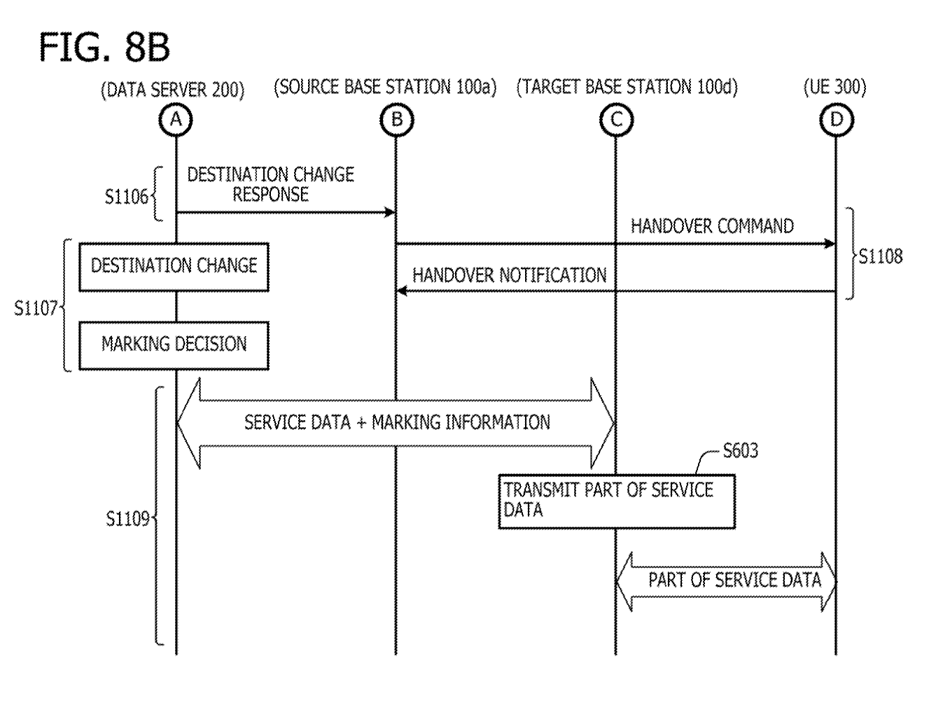

FIGS. 8A, 8B are diagrams illustrating an example of an operational sequence for performing a handover, according to an embodiment. In the example of FIGS. 8A, 8B, it is assumed that UE 300 is located in a cell controlled by source base station 100c, and a handover for UE 300 is performed from source base station 100c to target base station 100d. Further, it is also assumed that a transmission rate available for data transmission between source base station 100c and UE 300 is greater than a transmission rate available for data transmission between target base station 100d and UE 300.

In operation S1101, data server 200 transmits service data for UE 300 to source base station 100c, and source base station 100c transmits the received service data to UE 300 at a service rate required for transmitting the service data.

In operation S1102, when transmission quality between UE 300 and source base station 100c deteriorates, UE 300 transmits a report message indicating the deterioration of transmission quality to source base station 100c.

In operation S1103, when source base station 100c receives a report indicating the deterioration of transmission quality, call controller 111 of source base station 100c performs handover decision processing by determining whether a handover of UE 300 to target base station 100d should be performed or not. When call controller 111 has determined that the handover should be performed, source base station 100c transmits a handover request message to target base station 100d.

In operation S1104, upon receiving the handover request message, call controller 111 of target base station 100d acquires radio resources that are to be allocated to UE 300 after the handover. Further, call controller 111 calculates a transmission rate available for UE 300 based on the acquired radio resources. Thereafter, target base station 100d transmits, to source base station 100c, a handover response message together with a transmission rate available for UE 300 after the handover.

In operation S1105, upon receiving the handover response message, source base station 100c transmits, to data server 200, a destination change request message for requesting change of a transmission destination of service data for UE 300, from source base station 100c to target base station 100d, together with a transmission rate available for target base station 100d.

In operation S1106, when data server 200 receives the destination change request message, call controller 211 of data server 200 performs destination change processing for changing a transmission destination of service data for UE 300 from source base station 100c to target base station 100d.

In operation S1107, call controller 211 of data server 200 compares a transmission rate available for data transmission between UE 300 and target base station 100d, with a service rate required for transmitting service data for UE 300. Then, call controller 211 of data server 200 performs marking decision processing in which it is determined whether marking processing should be performed on the service data or not, and notifies marker 214 of the determination result. Marker 214 performs marking processing on the service data when the notified determination result indicates that marking processing should be performed. In the marking processing, marking information is provided for the service data, for example, by adding marking information to a part of the service data that is allowed to be transmitted from target base station 100d to UE 300. In the case, when a transmission rate available for target base station 100d is less than a service rate required for transmitting service data for UE 300, call controller 211 of data server 200 determines that marking processing should be performed on the service data, and marker 214, for example, adds marking information to a part of service data that is allowed to be transmitted from target base station 100d to UE 300 at a transmission rate available for the target base station 100d. Hereinafter, for ease of explanation, the part of service data to which marking information was added will be also expresses as “marked data”. Thereafter, data server 200 transmits the service data including the marked data to target base station 100d.

In operation S1108, source base station 100c, upon receiving a destination change response message from data server 200, requests UE 300 to perform a handover to target base station 100d by transmitting a handover command message to UE 300. As depicted in FIG. 8B, in parallel with operation S1108, operation S1107 may be performed by data server 200. UE 300, upon receiving the handover command message, performs a handover to target base station 100d, and transmits a handover notification message to source base station 100c.

In operation S1109, after the handover of UE 300 to target base station 100d, data server 200 performs marking processing on the service data for UE 300. When target base station 100d receives the service data from data server 200, marking processor 113 of target base station 100d extracts the part of service data to which marking information was added, from the received service data so as to transmit the extracted part of service data to UE 300, whereas marking processor 113 of target base station 100d may discard the other part of the service data to which marking information was not added.

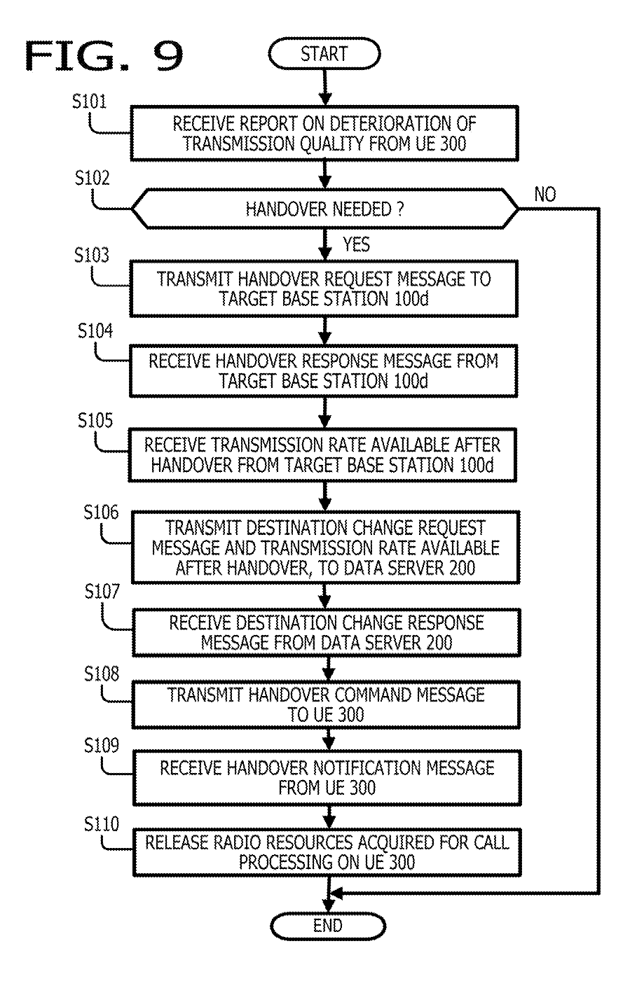

FIG. 9 is a diagram illustrating an example of an operational flowchart for handover processing performed by a source base station, according to an embodiment. In the example of FIG. 9, it is assumed that a handover is performed from source base station 100c to target base station 100d having a higher transmission quality for UE 300. Source base station 100c performs the following sequence of operations, as handover processing.

In operation S101, call controller 111 of source base station 100c receives a report on deterioration of transmission quality from UE 300.

In operation S102, call controller 111 of source base station 100c performs handover decision processing in which it is determined whether a handover to target base station 100d having a higher transmission quality for UE 300 is needed or not.

When it is determined that the handover to target base station 100d is needed (YES in operation S102), source base station 100c transmits a handover request message to target base station 100d (in operation S103).

In operations S104, S105, source base station 100c receives a handover response message from target base station 100d in response to the handover request message, together with a transmission rate available for target base station 100d after the handover.

In operation S106, source base station 100c transmits, to data server 200, a destination change request message for changing a transmission destination of service date for UE 300, together with a transmission rate available for target base station 100d.

In operation S107, source base station 100c receives a destination change response message from data server 200, in response to the destination change request message.

In operation S108, source base station 100c requests UE 300 to perform the handover by transmitting a handover command message to UE 300.

In operation S109, source base station 100c receives, from UE 300, a handover notification message indicating that the handover of UE 300 to target base station 100b has completed.

In operation S110, source base station 100c releases the radio resources that were acquired for call processing on UE 300, and ends the sequence of operations.

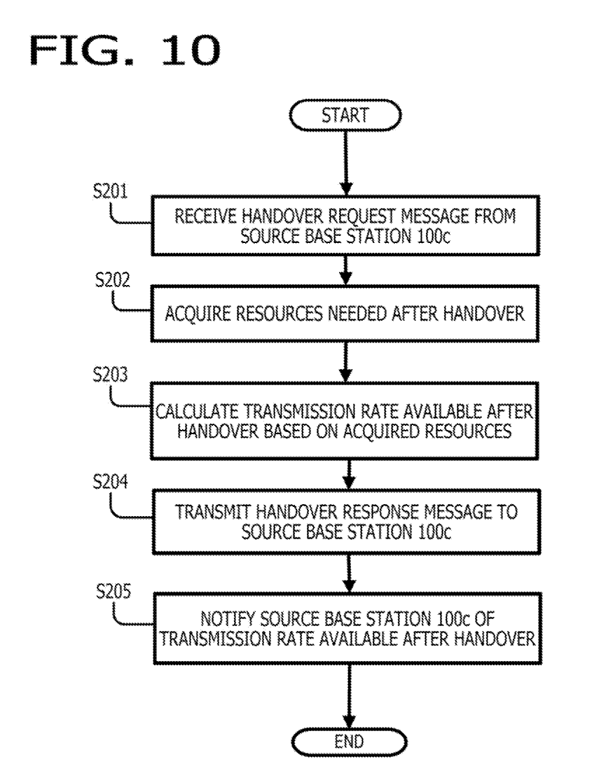

FIG. 10 is a diagram illustrating an example of an operational flowchart for handover processing performed by a target base station, according to an embodiment. In the example of FIG. 10, it is assumed that a handover is performed from source base station 100c to target base station 100d having a higher transmission quality for UE 300. Target base station 100d performs the following sequence of operations, as handover processing.

In operation S201, target base station 100d receives a handover request message from source base station 100c.

In operation S202, call controller 111 of target base station 100d acquires radio resources that are to be allocated for call processing on UE 300 after the handover has completed.

In operation S203, call controller 111 of target base station 100d calculates a transmission rate that is available for data transmission between target base station 100d and UE 300 after the handover has completed, based on the acquired radio resources.

In operations S204, S205, target base station 100d transmits, to source base station 100c, a handover response message together with the calculated transmission rate that is available for data transmission between target base station 100d and UE 300 after the handover has completed.

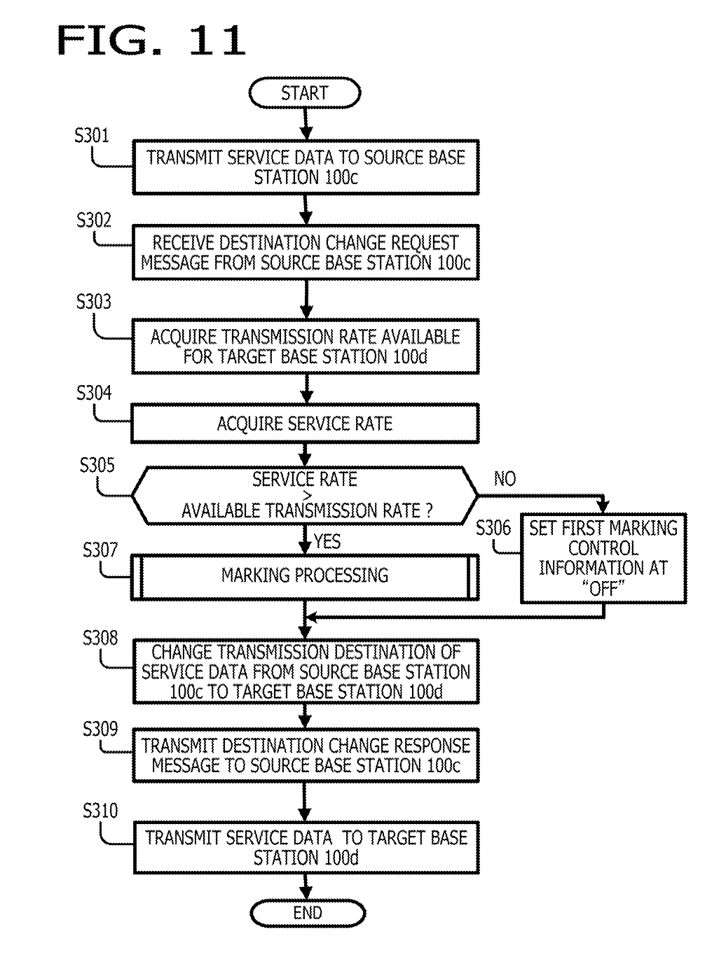

FIG. 11 is a diagram illustrating an example of an operational flowchart for handover processing performed by a data server, according to an embodiment. In the example of FIG. 11, it is assumed that a handover is performed from source base station 100c to target base station 100d when data server 200 is in the process of transmitting service date for UE 300, to source base station 100c accommodating UE 300. Data server 200 performs the following sequence of operations as handover processing.

In operation S301, data server 200 transmits service data to source base station 100c accommodating UE 300.

In operations S302, S303, data server 200 receives, from source base station 100c, a destination change request message for requesting data server 200 to change a transmission destination of the service data for UE 300, from source base station 100c to target base station 100d, together with a transmission rate available for data transmission between target base station 100d and UE 300 after the handover has completed.

In operation S304, call controller 211 of data server 200 acquires a service rate that is currently being used for transmitting the service data to UE 300 via source base station 100c.

In operation S305, call controller 211 of data server 200 determines whether a service rate required for transmitting the service data is greater than a transmission rate available for the target base station 100d by comparing the service rate acquired in operation S304 with the available transmission rate that was received from source base station 100c in operation S303.

When the acquired service rate is equal to or less than the transmission rate available for target base station 100d (NO in operation S305), it is unnecessary to perform marking processing for thinning out the service data because it is possible to transmit the service data from target base station 100d to UE 300 without thinning out the service data. Therefore, in this case, call controller 211 of data server 200 request marker 214 to set first marking control information at a value of “OFF” meaning that it is unnecessary to perform marking processing on the service data (in operation S306), and then processing shifts to operation S308.

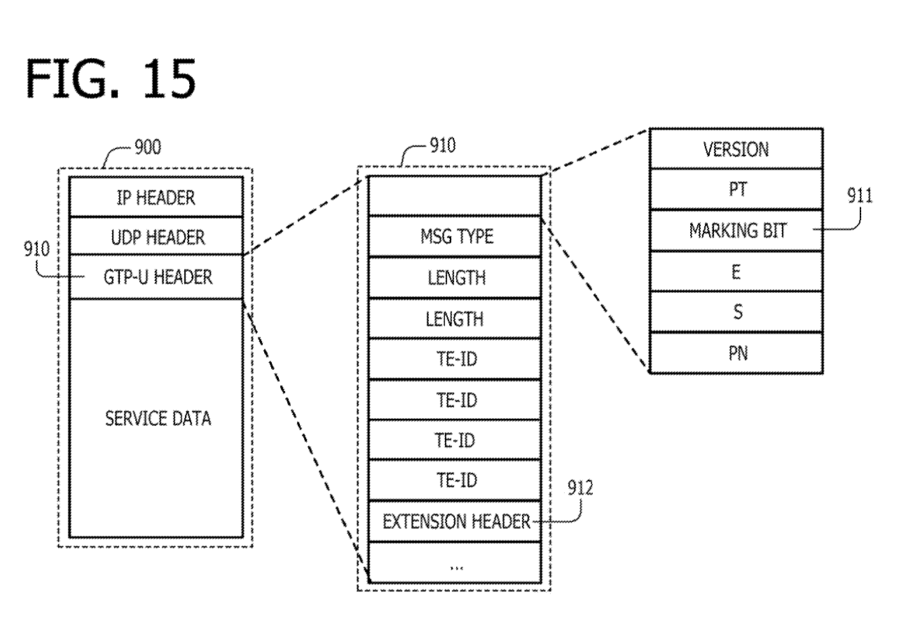

Meanwhile, when the acquired service rate is greater than the transmission rate available for target base station 100d (YES in operation S305), call controller 211 of data server 200 requests marker 214 to perform, on the service data, the marking processing for thinning out the service data (in operation S307). The detail of the marking processing will be described later with reference to FIGS. 15 to 19.

In operation S308, call controller 211 of data server 200 changes a transmission destination of the service data for UE 300, from source base station 100c to target base station 100d, based on the destination change request message received in operation S302. Here, operation S308 may be performed in parallel with operation S307, or just before operation S307.

In operation S309, data server 200 transmits, to source base station 100c, a destination change response message indicating that the transmission destination of the service data for UE 300 has been changed from source base station 100c to target base station 100d.

In operation S310, data server 200 transmits the service data for UE 300 to target base station 100d that has newly accommodated UE 300 after the handover.

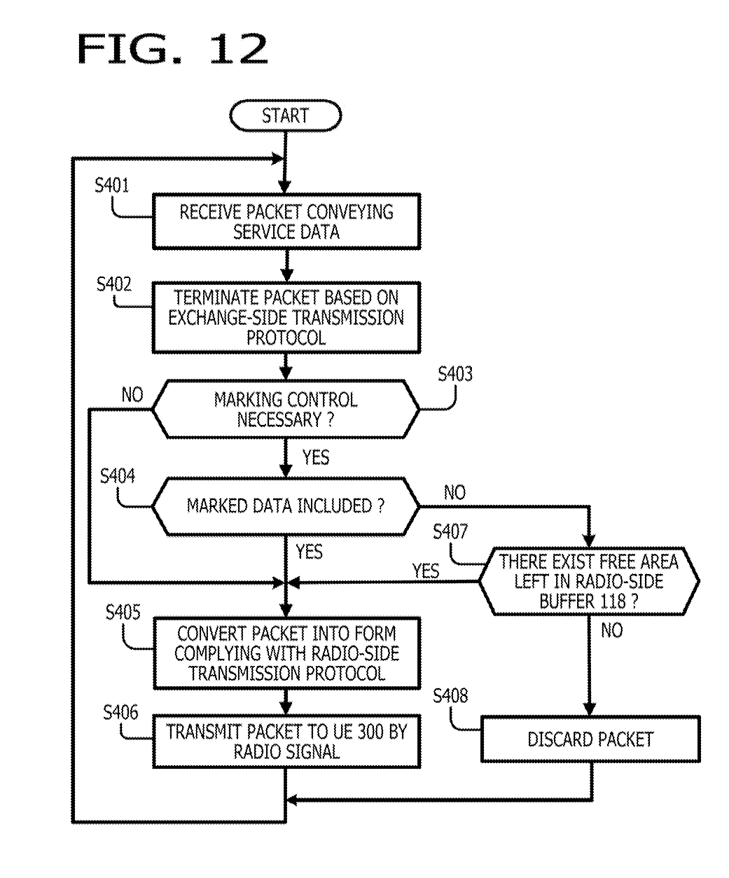

FIG. 12 is a diagram illustrating an example of an operational flowchart for transmission processing that is performed on service data by a target base station after a handover, according to an embodiment. In the example of FIG. 12, it is assumed that a handover of UE 300 from source base station 100c to target base station 100d has already completed. Target base station 100d performs the following sequence of operations, as transmission processing on service data after a handover.

In operation S401, after a handover to target base station 100d has completed, target base station 100d receives service data for UE 300 from data server 200, for example, via an exchange arranged in core network 112. For example, target base station 100d receives each of a plurality of packets conveying the service data. Here, data server 200 divides the service data into the plurality of packets, and transmits the plurality of packets to base station 100 based on a predetermined transmission protocol.

In operation S402, exchange-side terminator 112 of target base station 100d terminates each of the plurality of packets that have been transmitted from data server 200, based on a predetermined transmission protocol, or an exchange-side transmission protocol, that is used by data server 200 and exchanges arranged in core network 112.

In operation S403, marking processor 113, upon receiving a packet from exchange-side terminator 112, determines whether marking control is necessary or not, for example, by referring to first marking control information stored in a protocol header field of the received packet. In the case, for example, it is determined that marking control is necessary when the first marking control information is set at a value of “ON” meaning that the marking processing was performed on the packet by marker 214 of data server 200.

When it is determined that marking control is necessary (YES in operation S403), marking processor 113 further determines whether the received packet is conveying marked data (a piece of service data to which marking information was added) or not, for example, by referring to second marking control information stored in the protocol header field of the received packet (in operation S404).

When it is determined that the received packet includes marked data (YES in operation S404), marking processor 113 stores the received packet into radio-side buffer 118 so as to send the received packet to radio-side interface 116 via radio-side terminator 114.

Meanwhile, when it is determined that marking control is unnecessary (NO in operation S403), the processing shifts to operation S405.

In operations S405, radio-side terminator 114 converts the received packet that is stored in radio-side buffer 118, into a form complying with a radio-side transmission protocol, and sends the converted packet to radio-side interface 116.

In operations S406, radio-side interface 116, upon receiving the converted packet from radio-side terminator 114, transmits the converted packet to UE 300 by radio signal.

Meanwhile, when it is determined that the received packet does not include marked data (NO in operation S404), marking processor 113 further determines whether there exists a free area left in radio-side buffer 118 (in operation S407).

When it is determined that there exists a free area left in radio-side buffer 118 (YES in operation S407), marking processor 113 stores the packet (not including the marked data) into radio-side buffer 118, and the processing shifts to operation S405 in which radio-side terminator 114 converts the received packet (not including marked data) into a form complying with a radio-side transmission protocol, and sends the converted packet to radio-side interface 116.

Meanwhile, when it is determined that there exists no free areas left in radio-side buffer (NO in operation S407), marking processor 113 discards the packet (not including marked data) so as to thin out the service data (in operation S408).

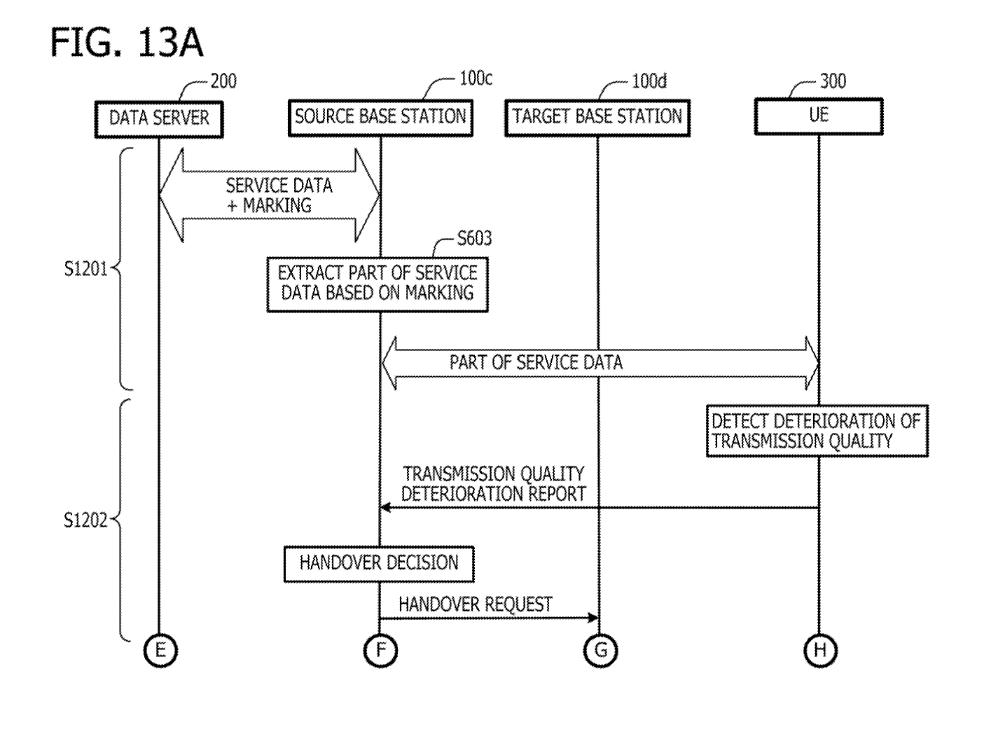

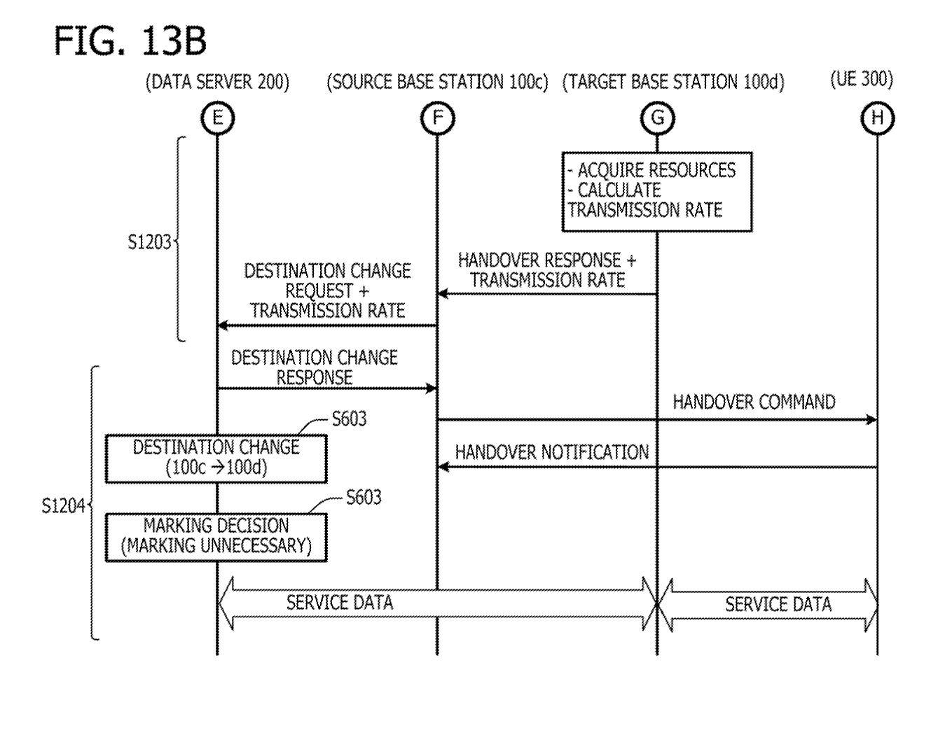

FIGS. 13A, 13B are diagrams illustrating an example of an operational sequence for performing a handover when a service rate does not exceed a transmission rate available after a handover, according to an embodiment. In the example of FIGS. 13A, 13B, it is assumed that, in an initial stae, transmission rate available for source base station 100c is less than a service rate required for transmitting the service data for UE 300, and marking processing is being performed on service data for UE 300. Further, it is assumed that a transmission rate available for target base station 100d is equal to or greater than the service rare.

In operation S1201, source base station 100c receives service data including marked data from data server 200, extracts a part of the service data to which marking information is added, from the received service data, and then transmits the extracted part of the service data to UE 300.

In operation S1202, upon receiving a report on deterioration of transmission quality from UE 300, source base station 100c determines whether a handover to target base station 100d is necessary or not, and transmits a handover request message to target base station 100d when it is determined that the handover to target base station 100d is necessary.

In operation 1203, target base station 100d, upon receiving the handover request from source base station 100c, acquires radio resources, calculates a transmission rate available for UE 300 after the handover, and notifies source base station 100c of the calculated transmission rate when transmitting a handover response message to source base station 100c. Upon receiving the handover response message, source base station 100c requests data server 200 to change a transmission destination of the service data for UE 300, by transmitting a destination change request message to data server 200 together with the calculated transmission rate.

In operation 1204, data server 200, upon receiving the destination change request message from source base station 100c, changes a transmission destination of the service data for UE 300, from source base station 100c to target base station 100d. Then, data server 200 perform marking decision processing by determining whether marking control is necessary or not by comparing the transmission rate received calculated by target base station 100d, with a service rate required for transmitting the service data for UE 300. In the case, since the calculated transmission rate is equal to or greater than the service rate of the service data for UE 300, it is unnecessary to thin out the service data. Therefore, the original service data is transmitted to UE 300 via target base station 100d.

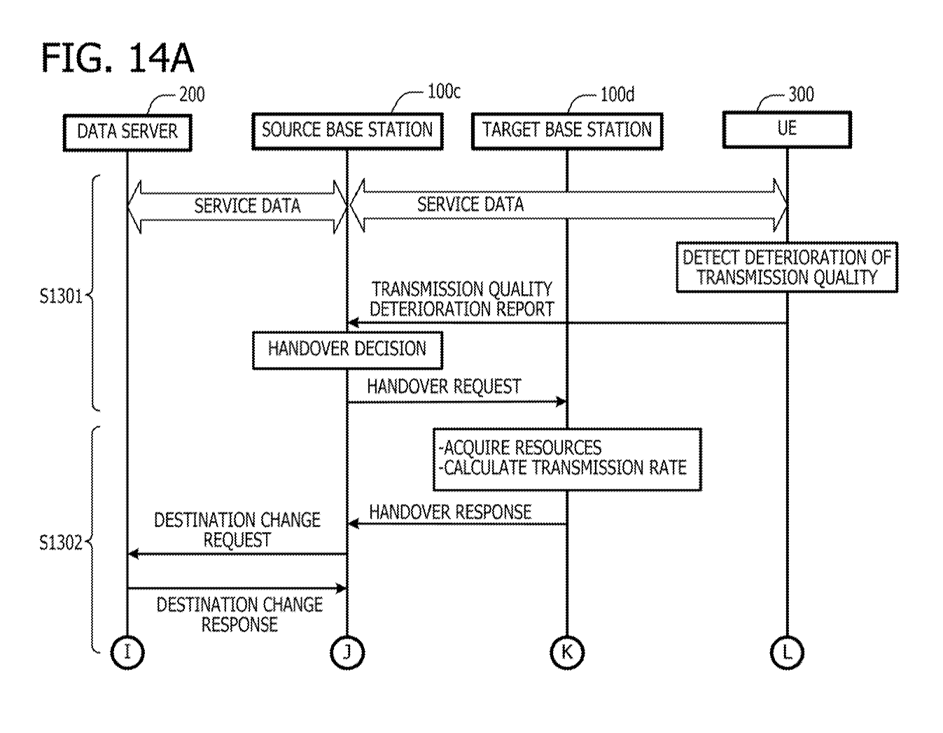

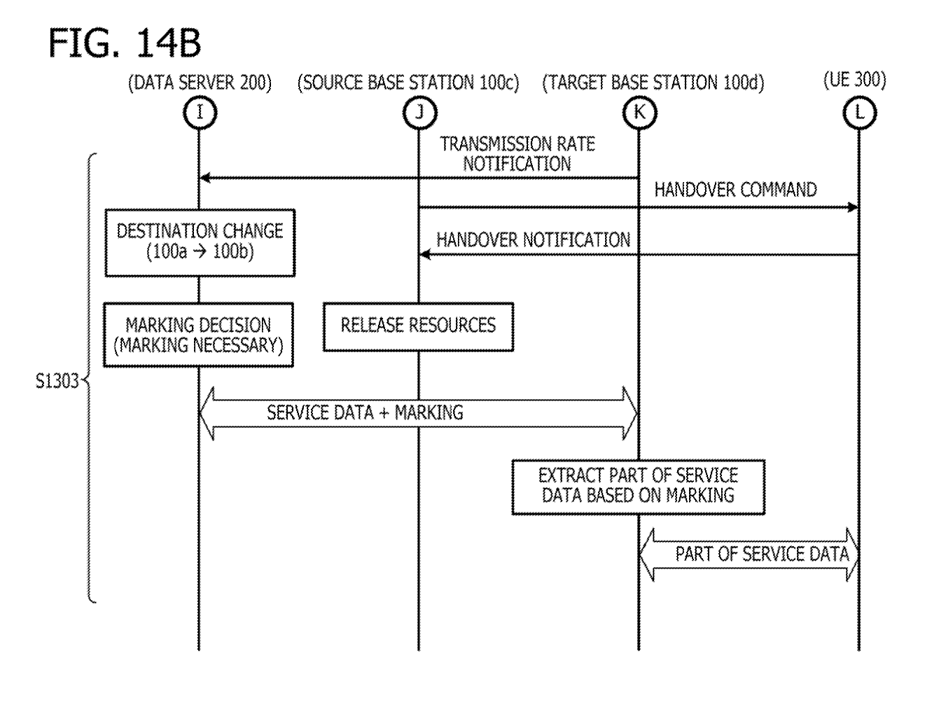

FIGS. 14A, 14B are diagrams illustrating an example of an operational sequence for performing a handover, in which a target base station transmits a transmission rate directly to a data server, according to an embodiment. In the example of FIGS. 14A, 14B, it is assumed that, in an initial state, a transmission rate available for source base station 100c is equal to or greater than a service rate required for transmitting the service data for UE 300, whereas a transmission rate available for target base station 100d is less than the service rate.

In operation S1301, service data for UE 300 is being transmitted without performing marking control. In the case, source base station 100c, upon receiving a report on deterioration of transmission quality from UE 300, determines whether a handover to target base station 100d is necessary or not. When it is determined that the handover to target base station 100d is necessary, source base station 100c transmits a handover request message to target base station 100d.

In operation S1302, target base station 100d, upon receiving the handover request message from source base station 100c, acquires radio resources, calculates a transmission rate available for UE 300 after the handover to target base station 100d, and transmits a handover response message to source base station 100c. At this time, source base station 100c is not notified of the transmission rate calculated by target base station 100d. Then, source base station 100c request data server 200 to change a transmission destination of the service data for UE 300, from source base station 100c to target base station 100d, by transmitting a destination change request message.

In operation S1303, target base station 100d notifies data server 200 of the calculated transmission rate available after the handover, by transmitting a transmission rate notification message directly to data server 200. Data server 200, upon receiving the transmission rate notification message from target base station 100d, changes a transmission destination of the service data for UE 300, from source base station 100c to target base station 100d, and performs marking decision processing by comparing the transmission rate notified by the target base station 100d with a service rate required for transmitting the service data for UE 300. In the case, since the transmission rate notified by the target base station 100d is less than the service rate, it is determined that marking processing is necessary so as to thin out the service data. Therefore, data server 200 performs marking processing, for example, by adding marking information to a part of the service data, and transmits the service data including the part to which marking information was added (the marked data), to target base station 100d. Upon receiving the service data including the marked data from data server 200, target base station 100d extracts the marked data from the received service data, and transmits the extracted marked data to UE 300 at the transmission rate that was notified to data server 200.

FIG. 15 is a diagram illustrating an example of a packet conveying service data including marked data, according to an embodiment. FIG. 15 illustrates, as an example, a packet that is used for carrying user data based on a GRP Tunneling Protocol (GTP). In the example of FIG. 15, two types of control information, first marking control information and second marking control information, are used for each of a plurality of packets conveying the service data to perform marking processing. The first marking control information indicates whether marking control is necessary for the service data or not, in other words, whether the service data includes marked data or not. Therefore, as the first marking information, the same value is set to all the plurality of packets conveying the same service data. For example, first marking control information may be configured as flag information that is set at a value of “ON” when marking control is necessary, and set at a value of “OFF” when marking control is unnecessary. The second marking control information indicates whether the packet conveys a piece of marked data or not. For example, the second marking information may be configured as flag information that is set at a value of “ON” when the packet stores a piece of marked data, and is set at a value of “OFF” when the packed does not store marked data at all. For ease of explanation, second marking control information set at value “ON” will be also expressed as “marker information”, and a part of service data to which second marking control information having value “ON” is added, will be expressed as “marked data”. In the same way, a packet to which second marking control information having value “ON” is added will be expressed as “a marked packet”.

The two types of marking control information may be stored in a protocol header field of each packet conveying a piece of service data. For example, the first marking control information may be stored in “marking bit” field 911 included in GTP-U (GPRS Tunneling Protocol for User data) field 910 of packet 900 as depicted in FIG. 15. Further, the second marking control information may be stored in a protocol header field of each packet conveying a piece of service data, for example, in an “extension header” field 912 as depicted in FIG. 15.

It is also possible to store the two types of marking control information in the fields of the packet other than the above mentioned fields as depicted in FIG. 15. However, it is not preferable to store the two types of marking control information in a “service data” field of the packet because the service data field generated by data server 200 is not terminated by base station 100d and, for example, modification of the service data field may exert an influence upon the processing of a terminal on the service data. Therefore, it is preferable to store the two types of marking control information in a protocol header field of the packet that is used for transmitting the plurality of packets according to an exchange-side transmission control (for example, a GRP Tunneling Protocol), and exerts no influences upon the processing on the service data performed by a terminal.

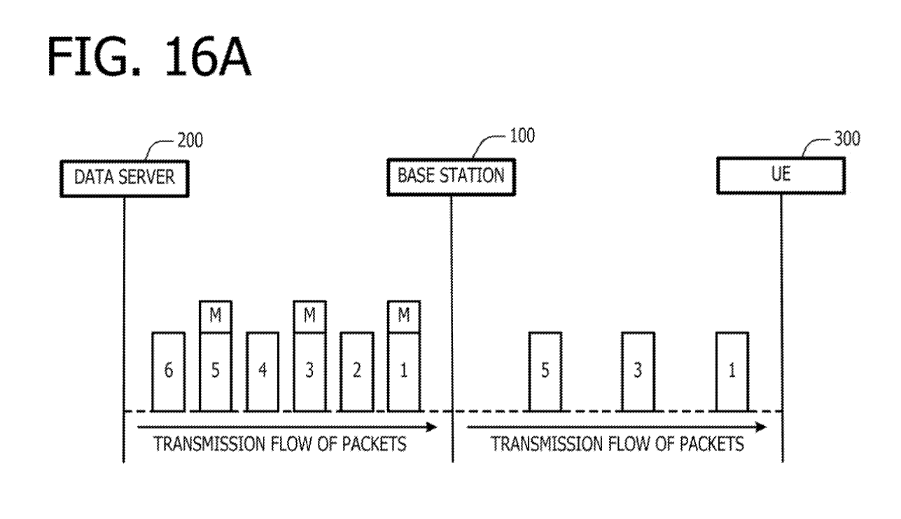

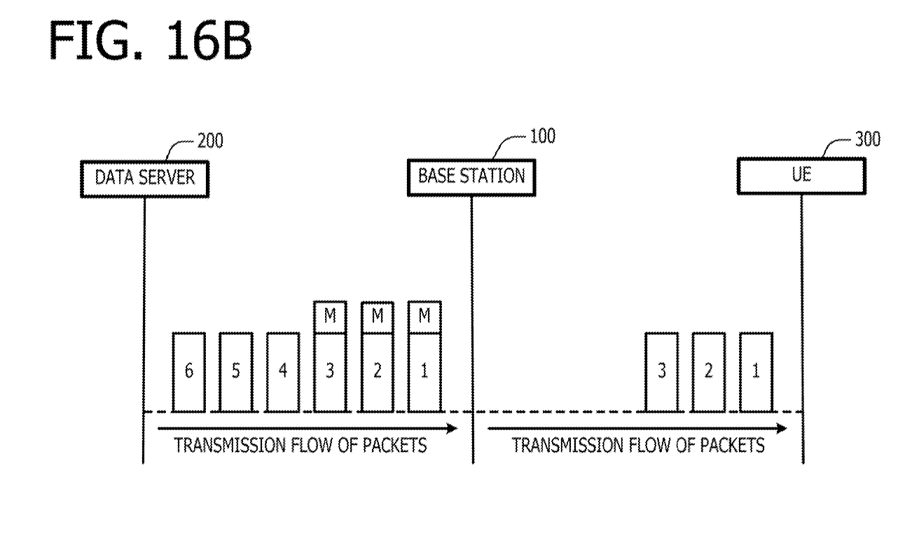

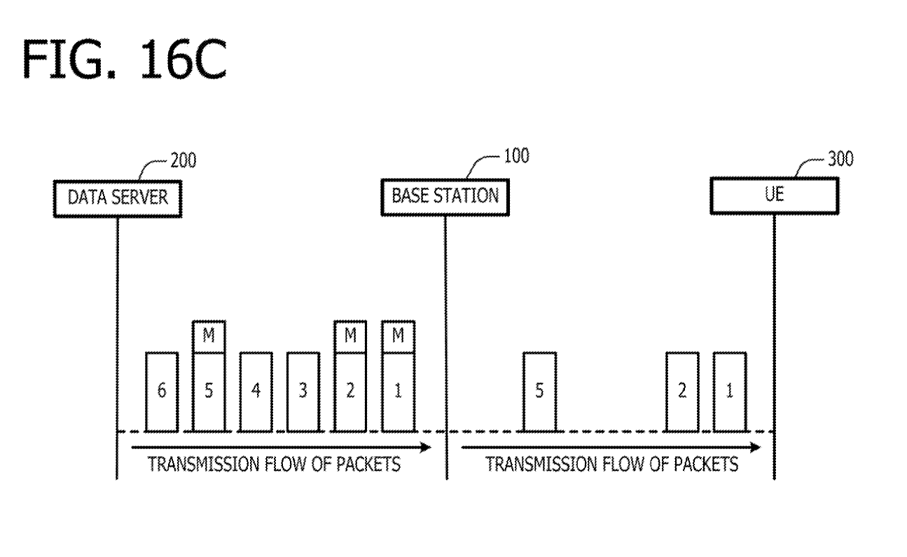

FIGS. 16A, 16B, 16C are diagrams each illustrating an example of a transmission flow of packets conveying service data including marked data, according to an embodiment. Marker 214 of data server 200 may be configured to add marking information to service data so that the amount of marked data is changed in proportion to the extent to which a service rate exceeds an available transmission rate. For example, when the ratio of a service rate to an available transmission rate is N:M (where N>M), marker 214 may be configured to add marking information to M pieces of service data out of N pieces of service data, and does not add marking information to the remaining N-M pieces of service data.

In the first example depicted in FIG. 16A, marker 214 may be configured to add marking information to M packets out of N packets at predetermined intervals. For example, as depicted in FIG. 16A, when N:M is set at “2:1” for transmitting six packets of service data numbered from 1 to 6 (denoted by boxes numbered 1 to 6, in FIG. 16A) in the order of transmission, marking information (denoted by “M” in FIG. 16A) may be added to the packets numbered 1, 3, 5. In this case, the packets numbered 1, 3, 5 may arrive at UE 300 at the same intervals. For example, in the case of service data that is generated from a content file such as a moving image file, a sequence of packets for conveying the marked data (a part of service data) may be transmitted to UE 300 at predetermined intervals, at a transmission rate lower than the service rate, in other words, at an effective service rate lower than the service rate. Thus, the effective service rate for the service data may be reduced without exerting a considerable influence upon the utilization of service data by a user.

In the second example depicted in FIG. 16B, marker 214 may be configured to add marking information to a burst of packets that are determined based on the ratio of a service rate to an available transmission rate. For example, marking information (denoted by “M” in FIG. 16B) may be added to the packets numbered from 1 to 3 out of the packets numbered from 1 to 6 (denoted by boxes numbered 1 to 6, in FIG. 16B), as depicted in FIG. 16B. In this case, for example, marking information may be added to a burst of packets conveying a part of the service data that has a relatively higher level of importance within the service data. As a result, the part of service data that has higher level importance may be transmitted to UE 300 at a transmission rate lower than the service rate, in other words, at an effective service rate lower than the service rate.

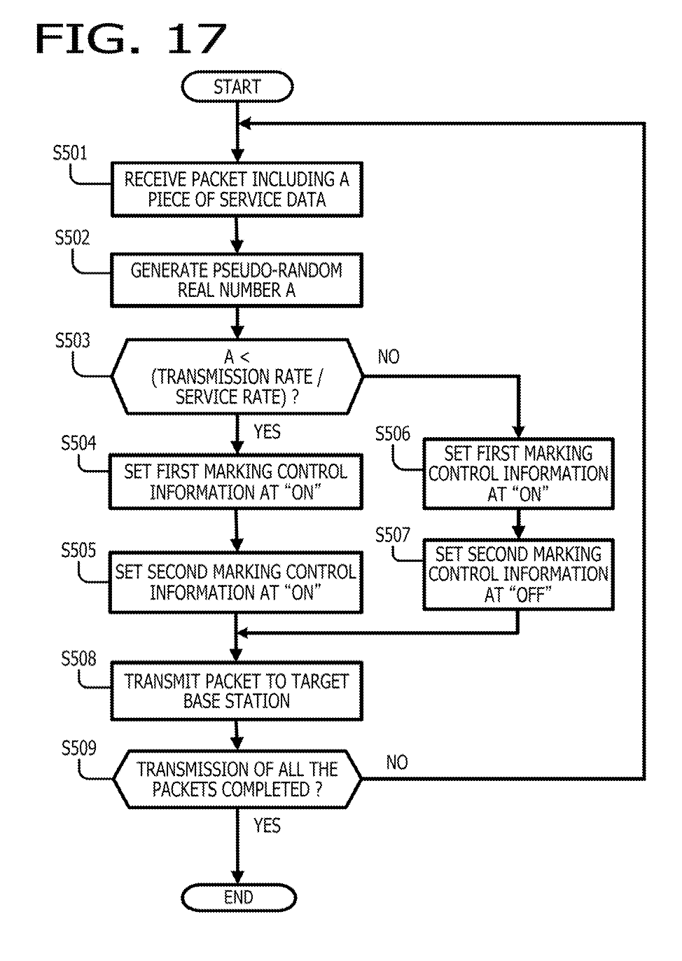

In the third example depicted in FIG. 16C, marker 214 may be configured to add marking information to packets that are randomly selected from packets conveying the service data. For example, as depicted in FIG. 16C, marking information (denoted by “M” in FIG. 16B) may be added to the packets numbered from 1, 2, 5 out of the packets numbered from 1 to 6 (denoted by boxes numbered 1 to 6, in FIG. 16C). The detail of marking processing for performing the third example will be given with reference to FIG. 17.

FIG. 17 is a diagram illustrating an example of an operational flowchart for marking processing performed by marker 214, according to an embodiment. In the example of FIG. 17, marking information is added to packets that are randomly selected from packets conveying service data.

In operation S501, marker 214 of data server 200 receives a packet including a piece of service data, from exchange-side protocol generator 213 that divides the service data into plural pieces of service data, and sends, to marker 214, a plurality of packets each including one of the plural pieces of service data.

In operation S502, marker 214 generates pseudo-random real number A ranging from real number “0” to real number “1”.

In operation S503, marker 214 compare the generated pseudo-random real number A with the ratio of an available transmission rate to a service rate. When the pseudo-random number A is smaller than the ratio of an available transmission rate to a service rate (YES in operation S503), marker 214 performs operations S504 and S505 as marking processing. In the marking processing, first, marker 214 sets first marking control information having value “ON” to a protocol header field of the packet, where the value “ON” indicates that marking processing has been performed on the packet (in operation S504). Next, marker 214 marks a piece of service data included in the packed by storing second marking control information having value “ON”, or marking information, to the protocol header field of the packet, where the value “ON” indicates that the piece of service data included in the packet was marked and allowed to be transmitted from target base station 100d to UE 300 (in operation S505).

Meanwhile, when the pseudo-random real number A is larger than the ratio of an available transmission rate to a service rate (NO in operation S503), marker 214 sets the first marking control information having value “ON” to a protocol header field of the packet (in operation S506), and further sets the second marking control information having value “OFF” to the protocol header field of the packet, where the value “OFF” indicates that the piece of service data included in the packet is not marked and allowed to be discarded without being transmitted to UE 300 (in operation S507).

In operation S508, marker 214 of data server 200 transmits the packet including the first and second marking control information to target base station 100d via exchange-side interface 216.

In operation S509, marker 214 repeats the above mentioned operations S501 to S508 until completion of transmitting all the plurality of packets conveying the service data.

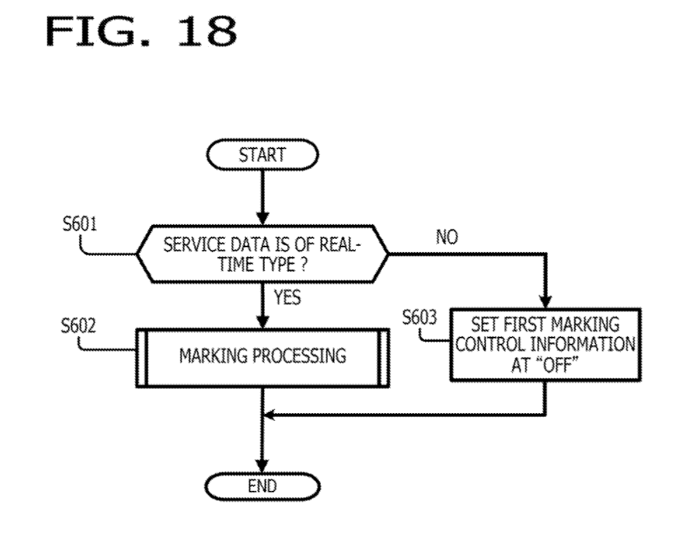

FIG. 18 is a diagram illustrating an example of an operational flowchart for marking processing performed by marker 214, according to an embodiment. In the example of FIG. 18, data server 200 is configured to determine whether marking processing is necessary or not, based on a type of service data.

In operation S601, it is determined whether service data is a real-time type of data, such as moving image data or music data, that is to be processed sequentially in real-time. When the service data is of a real-time type (YES in operation S601), marker 214 performs marking processing on the service data to thin out the service data, for example, in a manner similar to the marking processing as described in operations S504, S505 depicted in FIG. 17 (in operations S602). Meanwhile, when the service data is not of a real-time type (NO in operation S601), marker 214 sets first marking control information having value “OFF” to all the packets conveying the service data, where value “OFF” indicates that it is unnecessary to perform marking processing on a packet (in operation S603).

According to an embodiment as depicted in FIG. 18, marker 214 may be configured to perform marking processing on such a type of service data that is to be processed in real-time, so as to prevent data delay caused by the excess of a service rate over an available transmission rate. In the case, methods depicted in FIGS. 16A, 16B, 16C may be also used as marking processing for various sorts of service data that are to be processed in real-time. Further, marker 214 may be configured not to perform marking processing on such a type of service data that is not requested to be processed strictly in real-time, such as mail data. This prevents such type of service data from being thinning out by marking processing, and the original service data may be transmitted to UE 300 on a priority basis.

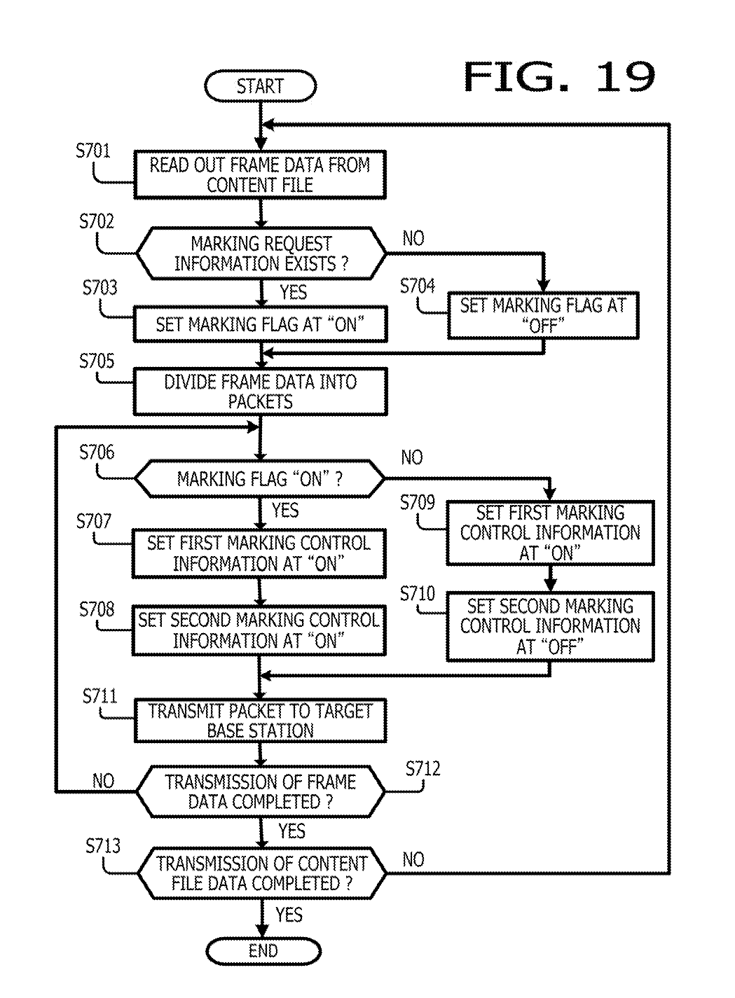

FIG. 19 is a diagram illustrating an example of an operational flowchart for marking processing performed by marker 214, according to an embodiment. In the example of FIG. 19, data server 200 may be configured to determine whether it is necessary to perform marking processing on a packet or not, based on marking request information included in a content file that is stored in data storage 215. In the example of FIG. 19, it is assumed that there exists marking request information stored in each of frames conveying a content file when marking information should be added to service data included in the each of frames.

In operation S701, service data generator 212 reads out a frame of service data (or frame data) from a content file that is to be provided for UE 300.

In operation S702, it is determined whether there exists marking request information stored in the frame. When there exists the marking request information stored in the frame (YES in operation S702), service data generator 212 sets a marking flag at “ON” meaning that marking information is to be added to service data stored in the frame (in operation S703). Meanwhile, when there exists no marking request information stored in the frame (NO in operation S702), service data generator 212 set the marking flag at value “OFF” meaning that it is unnecessary to add marking information to service data stored in the frame data (in operation S704).

In operation S705, exchange-side protocol generator 213 divides the piece of service data stored in the frame, into packets to be transmitted. Thereafter, exchange-side protocol generator 213 sequentially selects a packet from the packets, and sends the selected packet to marker 214.

In operation S706, upon receiving a packet from exchange-side protocol generator 213, marker 214 determines whether the marking flag is being set at “ON” or not (in operation S706). When the marking flag is being set at “ON”, marker 214 sets first marking control information having value “ON” to a protocol header of the received packet (in operation S707), and further sets second marking control information having value “ON” to the protocol header of the received packet (in operation S708). Meanwhile, when the marking control flag is being set at “OFF” (NO in operation S706), marker 214 sets first marking control information having value “ON” to the protocol header of the received packet (in operation S709), and further sets second marking control information having value “OFF” to the protocol header of the received packet (in operation S710).

In operation S711, marker 214 transmits the packet including the first and second marking control information to target base station 100d via exchange-side interface 216.

In operation S712, marker 214 determines whether all the packets conveying the frame data have been transmitted to target base station 100d or not. When it is determined that all the packets conveying the frame data have not been transmitted to target base station 100d (NO in operation S712), marker 214 requests exchange-side protocol generator 213 to send a next packet to marker 214, and the processing shifts to operation S706.

In operation S713, data server 200 further repeats the above mentioned operations from S701 to S712 until all the frames conveying the content file have been transmitted.

According to the example depicted in FIG. 19, addition of marking information to service data may be controlled based on marking request information that is beforehand embedded in a content file. For example, in the case of content file including moving image data, it may be possible to embed marking request information into frames that conveys a part of service data that has relatively higher importance, such as telop data, so that the part of service data arrives at UE 300 with reliability.

As mentioned above, according to an embodiment, in the case of a handover between base stations each employing a different transmission method, a target base station to which the handover is to be performed calculates a transmission rate available after the handover, and notifies a source base station from which the handover is performed, of the calculated transmission rate. This allows the source base station to notify a data server for providing a service, of a transmission rate available for the target base station after the handover.

The data server compares a transmission rate available for the target base station after the handover, with a service rate required for transmitting service data. When the service rate exceeds the transmission rate available after the handover, the data server starts to perform marking processing in which marking information is set to a part of service data so that the magnitude of the part is changed according to the extent to which the service rate exceeds the available transmission rate.

When the target base station receives the service data including the marked data from the data server after the handover, the target base station extracts the marked data from the received service data, and transmits the extracted marked data to the terminal at the transmission rate available for the target base station, while the other part of service data to which second marking control information having value “OFF” is added, may be discarded without being transmitted to the terminal.

This allows the target base station to transmit only the part of service data to a terminal, thereby reducing the amount of service data that is transmitted to the terminal. In other words, an effective service rate requited for transmitting service data to the terminal may be reduced. Therefore, even if a transmission rate after a handover becomes low in comparison to that before the handover, it may be possible to continue the appropriate transmission of service data while maintaining a certain level of service quality.

A target base station may be configured to transmit service data to a terminal depending on an available transmission rate after temporarily storing the service data into a memory (for example, radio-side buffer 118). In the case, when radio-side buffer 118 is in a state of a low occupancy rate and there exists a free area left, it is unlikely that transmission delay occurs even if data is temporarily stored in radio-side buffer 118, and the data may be successfully transmitted to the terminal. Configuring a target base station in this way allows appropriate transmission of service data depending on a transmission rate available for the target base station, while preventing the data that is not marked, from being discarded.

Meanwhile, when radio-side buffer 118 is in a state of a high occupancy rate and there exists no free areas left, transmission delay may be caused by temporarily storing data into radio-side buffer 118. Therefore, it is preferable to discard the data to which marking information is not added, so as to keep supply of services.

In the example described above, description was given of the case where a transmission rate available for UE 300 changes when UE 300 performs a handover, as a representative example. However, it is also possible to perform the above mentioned marking processing when a transmission rate available for UE 300 changes due to some other factors. In this case, the embodiment may also be effective in keeping appropriate transmission to UE 300.

In the above description, although description was given of the case where service data is provided by data server 200, other configurations may be possible. For example, when data transmission is performed from first UE 300 to second UE 300, the first and second UEs 300 may be configured to employ a method for performing the above mentioned marking processing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A system comprising:
a base station configured to transmit service data to a terminal at a first transmission rate available for data transmission between the base station and the terminal; and
a server configured to transmit the service data to the base station at a second transmission rate required for transmitting the service data, wherein
the base station notifies the server of the first transmission rate;
the server performs marking processing on the service data when the first transmission rate is less than the second transmission rate, the marking processing comprising:
determining a first part of the service data by thinning out the service data so that the first part is able to be transmitted to the terminal at the first transmission rate,
providing the determined first part of the service data with marking information, and
transmitting the service data provided with the marking information to the base station at the second transmission rate; and
the base station extracts the first part from the received service data based on the marking information provided for the first part of the service data, and transmits the extracted first part of the service data to the terminal at the first transmission rate.

2. The system of claim 1, wherein
the base station includes a memory for temporarily storing data that is to be transmitted to the terminal at the first transmission rate;
the base station stores, in addition to the first part of service data, a second part of service data that is outside the first part of service data, into the memory when there exists a free area left for storing the second part of service data within the memory; and
the base station transmits, in addition to the first part of service data, the second part of service data to the terminal at the first transmission rate.

3. The system of claim 1, wherein
the server performs the marking processing on the service data when the service data is of a real-time type that requests the terminal to process the received service data in real time.

4. The system of claim 1, wherein
data transmission between the server and the base station is performed by transmitting a plurality of packets conveying the service data based on a predetermined transmission protocol, each of the plurality of packets including a protocol header for controlling transmission of the plurality of packets according to the predetermined transmission protocol, and
the marking information is provided for the first part of service data by storing the marking information into the protocol header included in a packet conveying the first part of service data.

5. A method for transmitting service data from a server to a terminal via a base station, the method comprising:
notifying, by the base station, the server of a first transmission rate available for data transmission between the base station and the terminal;
performing, by the server, marking processing on the service data when the first transmission rate is less than a second transmission rate required for transmitting the service data, the marking processing comprising:
determining a part of the service data by thinning out the service data so that the part is able to be transmitted to the terminal at the first transmission rate,
providing the determined part of service data with marking information, and
transmitting the service data provided with the marking information to the base station at the second transmission rate;
extracting, by the base station, the part from the received service data based on the marking information provided for the part of the service data; and
transmitting, by the base station, the extracted part of the service data to the terminal at the first transmission rate.

6. A base station for transmitting service data received from a server to a terminal, comprising:
a memory configured to temporarily store the service data received from the server; and
a processor configured
to notify the server of a first transmission rate available for data transmission between the base station and the terminal,
to receive the service data from the server at a second transmission rate required for transmitting the service data, the received service data including a part of service data provided with marking information, and
to store the received service data in the memory, wherein
the processor extracts the part of service data from the received service data stored in the memory, based on the marking information provided for the part of service data, and transmits the extracted part of service data to the terminal at the first transmission rate.

7. A server for transmitting service data to a terminal via a base station, comprising:
a memory configured to store the service data to be transmitted to the base station; and
a processor configured
to receive, from the base station, a first transmission rate available for data transmission between the base station and the terminal,
to perform marking processing on the service data when the first transmission rate is less than a second transmission rate required for transmitting the service data, wherein the marking processing comprises:
determining a part of service data by thinning out the service data so that the part is able to be transmitted to the terminal at the first transmission rate,
providing the determined part of service data with marking information, and
transmitting the service data provided with the marking information to the base station at the second transmission rate.
